(19) United States
(12) Patent Application Publication
(10) Pub. No.: US 2015/0043063 A1
(43) Pub. Date: Feb. 12, 2015

(54) CATADIOPTRIC SYSTEM AND IMAGE PICKUP APPARATUS INCLUDING THE SYSTEM

(71) Applicant: CANON KABUSHIKI KAISHA, Tokyo (JP)

(72) Inventor: Kazuhiko Kajiyama, Utsunomiya-shi (JP)

(21) Appl. No.: 14/455,596

(22) Filed: Aug. 8, 2014

(30) Foreign Application Priority Data
Aug. 12, 2013 (JP) 2013-167376

(51) Int. Cl. G02B 17/08; G02B 21/00

(52) U.S. Cl. CPC G02B 17/0804; G02B 21/0004
USPC 359/365

(57) ABSTRACT

A catadioptric system includes: a catadioptric unit configured to form an intermediate image of an object; a refracting portion configured to form an image of the intermediate image; a first field lens configured to guide optical flux from the catadioptric unit to the refracting portion; and a second field lens configured to guide the optical flux from the refracting portion toward an image side. The first and the second field lenses each include a positive lens and a negative lens adjacent to each other, and wherein where νIFLp1 and νIFLn1 are respectively Abbe numbers of materials of the positive lens and the negative lens of the first field lens, and νFLp1 and νFLn1 are respectively Abbe numbers of materials of the positive lens and the negative lens of the second field lens, conditions

20<νIFLp1−νIFLn1 and

20<νFLp1−νFLn1

are satisfied.

### BACKGROUND OF THE INVENTION

1. Field of the Invention

This disclosure relates generally to optical systems and in particular to an image pickup apparatus suitable for observing a sample (object) at an enlarged scale.

2. Description of the Related Art

In pathological examination, a pathological specimen (sample) is directly observed with a human eye by using an optical microscope. In recent years, a so-called “virtual microscope” configured to import a pathological specimen as image data and present the image data on a display for observation has been proposed and put in practical use. Since the virtual microscope allows observation of the image data of the pathological specimen on a large display, a plurality of persons can observe the image data on the display simultaneously. Usage of the virtual microscope has many advantages such that the image data can be shared with a pathologist at a distance to obtain his or her diagnosis. However, this method of presenting image data for observation takes a long time to take an image of the pathological specimen and import the image as image data.

One of the reasons why it takes a long time is that a pathological specimen having a large image pickup range needs to be imported as image data by using a narrow image pickup area of the microscope. In the case where the image pickup area of the microscope is narrow, it is necessary to form a single image by picking up an image a plurality of times or picking up an image while scanning the sample, and then connecting (combining) the taken images. In the related art, in order to reduce the time required to import the image data by reducing the number of times image pickup is performed, an optical system (image pickup optical system) having a large image pickup area is required.

In addition, there is a demand for an optical system having a high resolution power in a visible range (wide wavelength range) as well as a demand for a wide image pickup area for observing the pathological specimen. In order to reduce an error (magnification change or the like) in analysis of the image data caused by a positional error between the pathological specimen to be subject to image pickup and an image pickup element in a direction of an optical axis, an optical system is required to have good telecentric properties both on an object side and an image side thereof.

In the related art, a catadioptric optical system for an ultraviolet microscope having a high resolution power over a wide ultraviolet wavelength band by using a catadioptric system for inspecting dust or the like existing on an integrated circuit or a photo mask is known (U.S. Patent No. 2004/0240047). A catadioptric system suitable for manufacturing a semiconductor element by exposing a fine pattern over a wide area is also known (International Publication No. WO/2000/039623).

In general, the image pickup optical system for the virtual microscope is required to have high optical performance with aberrations such as spherical aberration, comatic aberration, and astigmatism, satisfactorily corrected over a wide range of visual field. In addition, having a good telecentric property both on the object side and the image side is required. For example, in the case of a narrow image pickup area, the aberration of a pupil is small, and hence a difference in telecentric property per wavelength can be easily managed. However, in the optical system having a wide image pickup area, the aberration of the pupil is large, and hence the telecentric property may vary from one wavelength to another.

If the telecentric property varies from one wavelength to another and an incident angle on an image pickup surface (image surface) varies from one wavelength to another, a chromatic aberration of magnification is generated when performing focusing on the image pickup element side. When picking up an image by the optical system having a large image pickup area, there may be a case where a single piece of image data is obtained using arranging a plurality of image pickup elements in parallel and picking up images a plurality of times. When the telecentric property is different from one wavelength to another, arrangement accuracy of individual image pickup elements becomes important.

The catadioptric imaging system disclosed in U.S. Patent No. 2004/0240047 satisfactorily reduces the various aberrations over an entire visual light range, and has a high resolution power. However, the size of an observation range is not necessarily sufficient for certain applications. Although the catadioptric imaging system disclosed in International Publication No. WO/2000/039623 has a high resolution power over a wide wavelength range, the size of the wavelength range in which correction of the various aberrations or the telecentric property are satisfactorily maintained is not necessarily sufficient.

### SUMMARY OF THE INVENTION

This disclosure provides an image pickup apparatus including a catadioptric system in which various aberrations are satisfactorily corrected over an entire visual light range, having a high resolution power over a wide image pickup area, and having a high telecentric property.

An image pickup apparatus according to an aspect of this disclosure is a catadioptric system including: a catadioptric unit configured to form an intermediate image of an object; a refracting portion configured to form an image of the intermediate image; a first field lens configured to guide optical flux from the catadioptric unit to the refracting portion; and a second field lens configured to guide the optical flux from the refracting portion toward an image side, wherein the first and the second field lenses each include a positive lens and a negative lens adjacent to each other, and wherein where νIFLp1 and νIFLn1 are respectively Abbe numbers of materials of the positive lens and the negative lens of the first field lens, and νFLp1 and νFLn1 are respectively Abbe numbers of materials of the positive lens and the negative lens of the second field lens, conditions

20<νIFLp1−νIFLn1 and

20<νFLp1−νFLn1

are satisfied.

Further features of the present invention will become apparent from the following description of exemplary embodiments with reference to the attached drawings.

### BRIEF DESCRIPTION OF THE DRAWINGS

FIG. 1 is a schematic cross-sectional view illustrating a configuration of an image pickup apparatus of this disclosure.

FIG. 2 is a schematic drawing of a principal portion of Example 1 of a catadioptric system of this disclosure.

FIGS. 3A and 3B are schematic drawings of a field lens of Example 1 of the catadioptric system of this disclosure.

FIG. 4 is a transverse aberration diagram of Example 1 of the catadioptric system of this disclosure.

FIG. 5 is a schematic drawing of a principal portion of Example 2 of the catadioptric system of this disclosure.

FIGS. 6A and 6B are schematic drawings of a field lens of Example 2 of the catadioptric system of this disclosure.

FIG. 7 is a transverse aberration diagram of Example 2 of the catadioptric system of this disclosure.

FIG. 8 is a schematic drawing of a principal portion of Example 3 of the catadioptric system of this disclosure.

FIGS. 9A and 9B are schematic drawings of a field lens of this disclosure.

FIG. 10 is a transverse aberration diagram of Example 3 of the catadioptric system of this disclosure.

### DESCRIPTION OF THE EMBODIMENTS

Hereinafter, a catadioptric system and an image pickup apparatus having the same of this disclosure will be described. The image pickup apparatus of this disclosure includes a catadioptric system configured to form an image of an object, and an image pickup element configured to perform photoelectric conversion on an image of the object formed by the catadioptric system. The catadioptric system which constitutes part of the image pickup apparatus of this disclosure includes a catadioptric unit configured to condense optical flux from the object and form an intermediate image of the object, and an intermediate field lens arranged at a position where the intermediate image is formed or in the vicinity thereof.

In addition, a refracting (refractive) portion configured to form the intermediate image on the image surface (image pickup element), and an image-side field lens configured to introduce the optical flux from the refracting portion toward the image side are also provided. The intermediate field lens and the image-side field lens each include a positive lens and a negative lens.

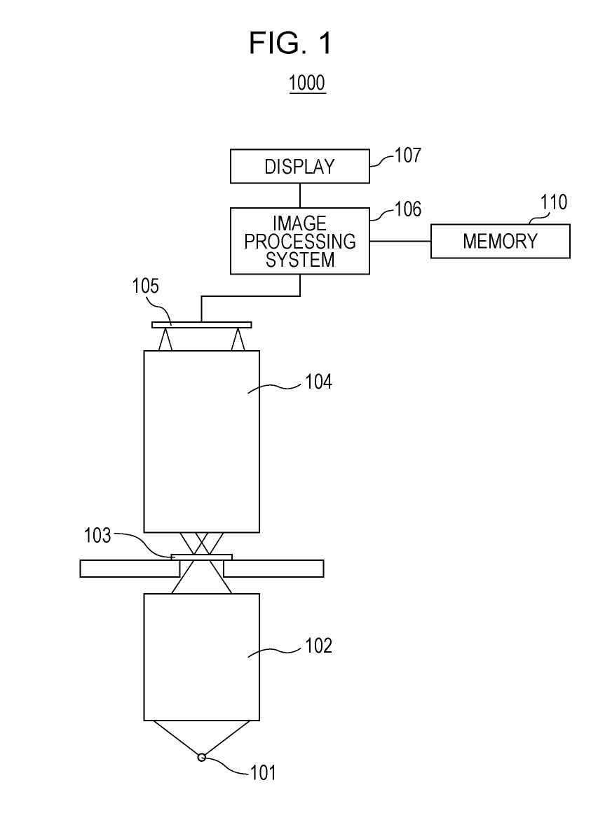

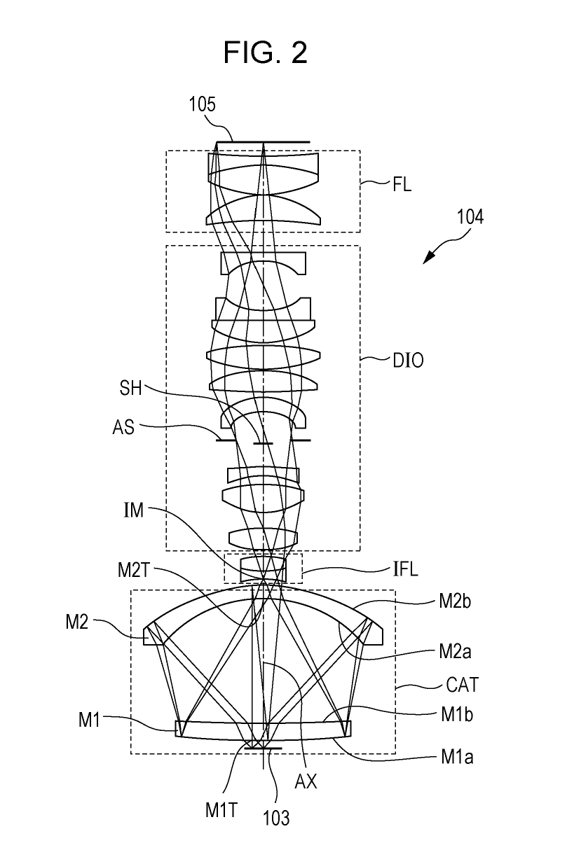

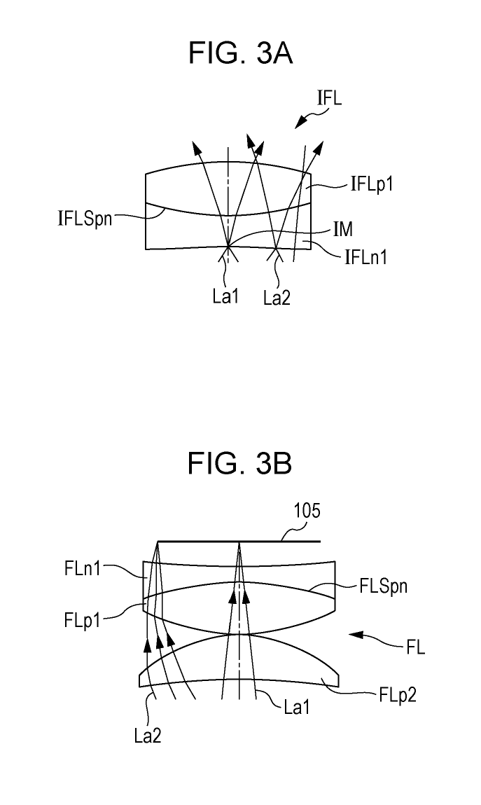

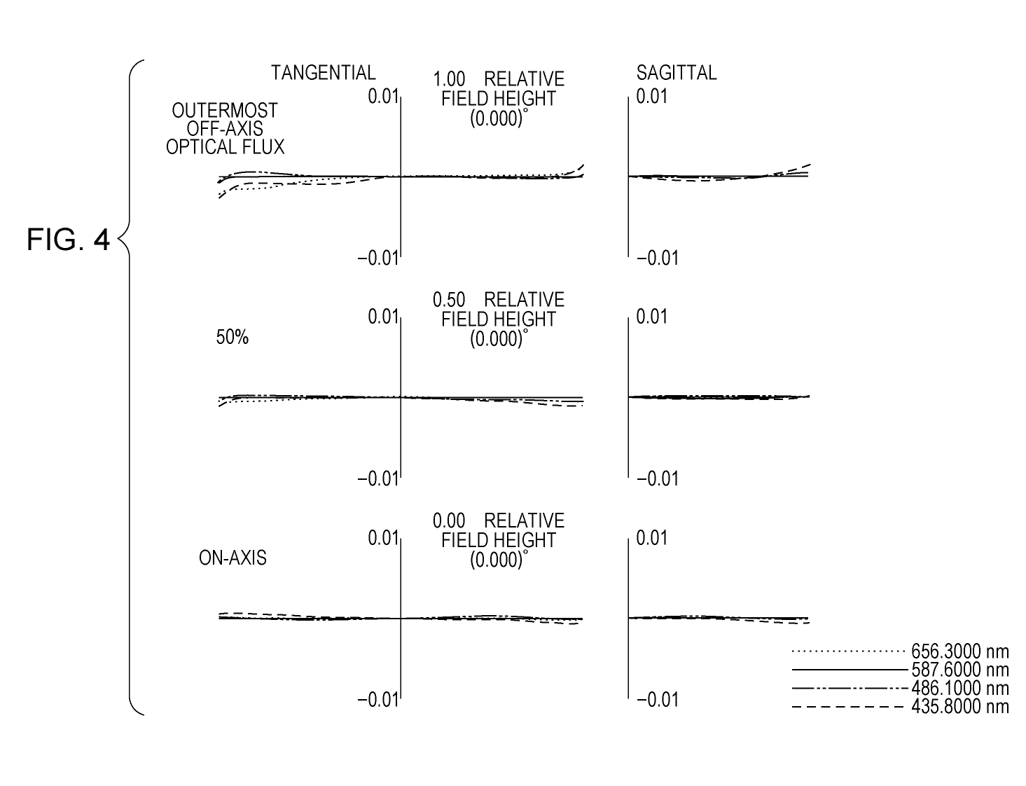

FIG. 1 is a schematic drawing of a principal portion of the image pickup apparatus of this disclosure. FIG. 2 is a schematic drawing of a principal portion of Example 1 of a catadioptric system which constitutes part of the image pickup apparatus of this disclosure. FIGS. 3A and 3B are schematic drawings illustrating principal portions of the intermediate field lens and the image-side field lens of part of Example 1 of the catadioptric system of this disclosure. FIG. 4 is a transverse aberration diagram of Example 1 of the catadioptric system of this disclosure.

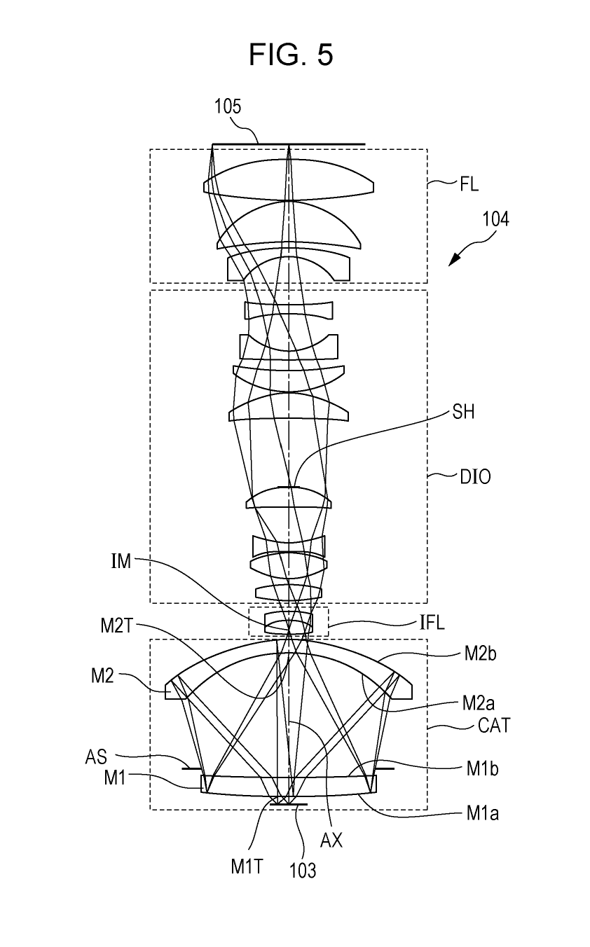

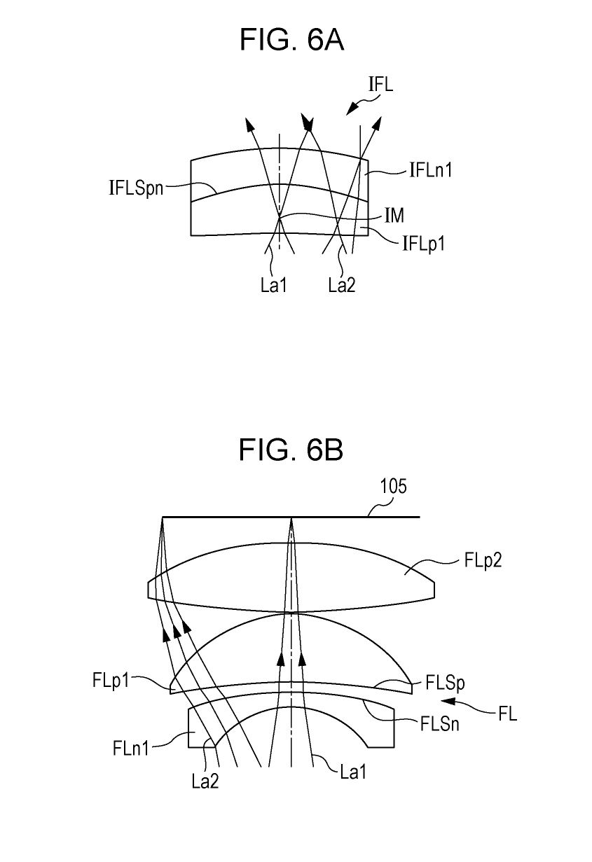

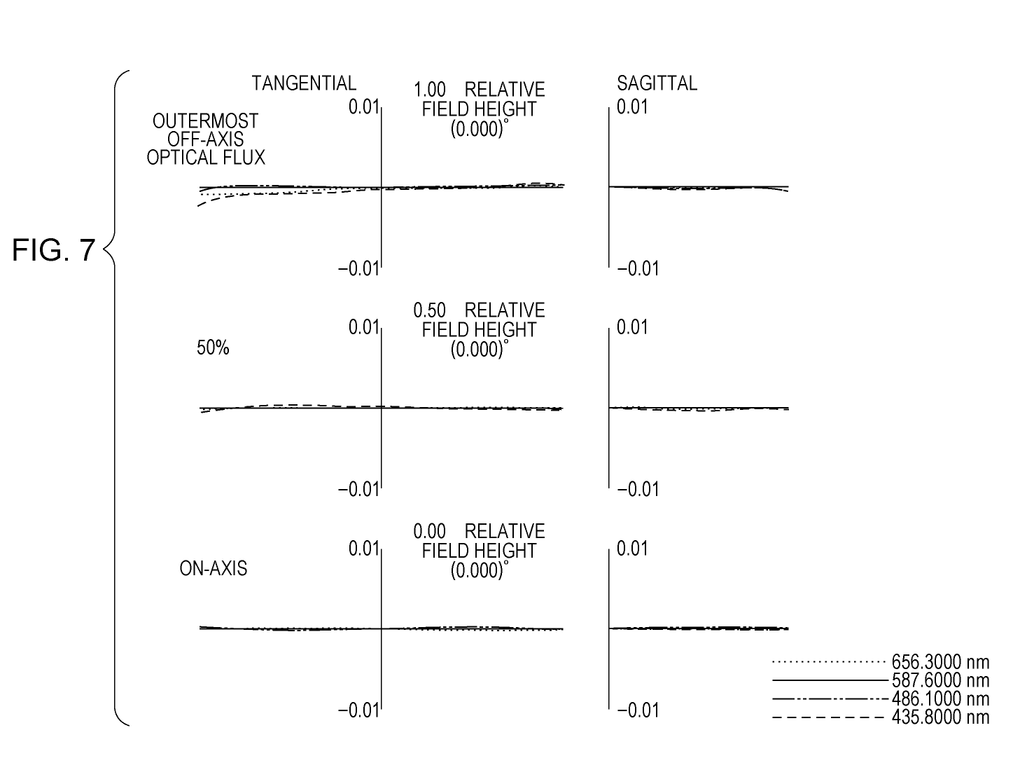

FIG. 5 is a schematic drawing of a principal portion of Example 2 of the catadioptric system which constitutes part of the image pickup apparatus of this disclosure. FIGS. 6A and 6B are respectively schematic drawings illustrating principal portions of the intermediate field lens and the image-side field lens of part of Example 2 of the catadioptric system of this disclosure. FIG. 7 is a transverse aberration diagram of Example 2 of the catadioptric system of this disclosure.

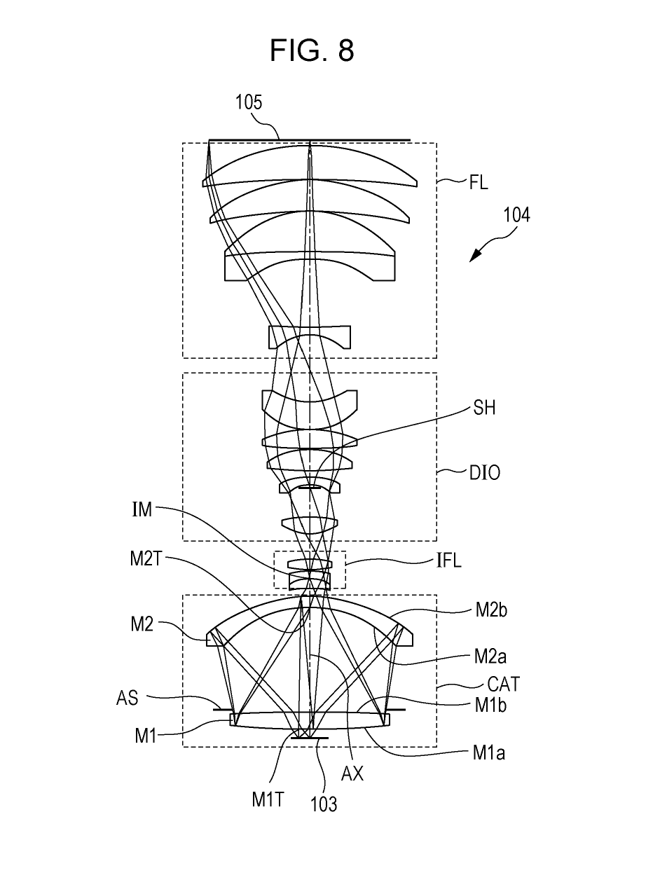

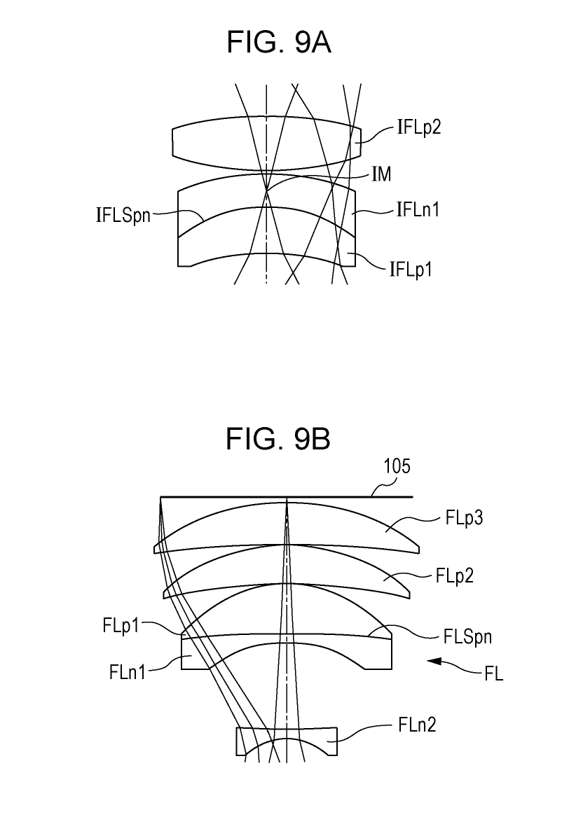

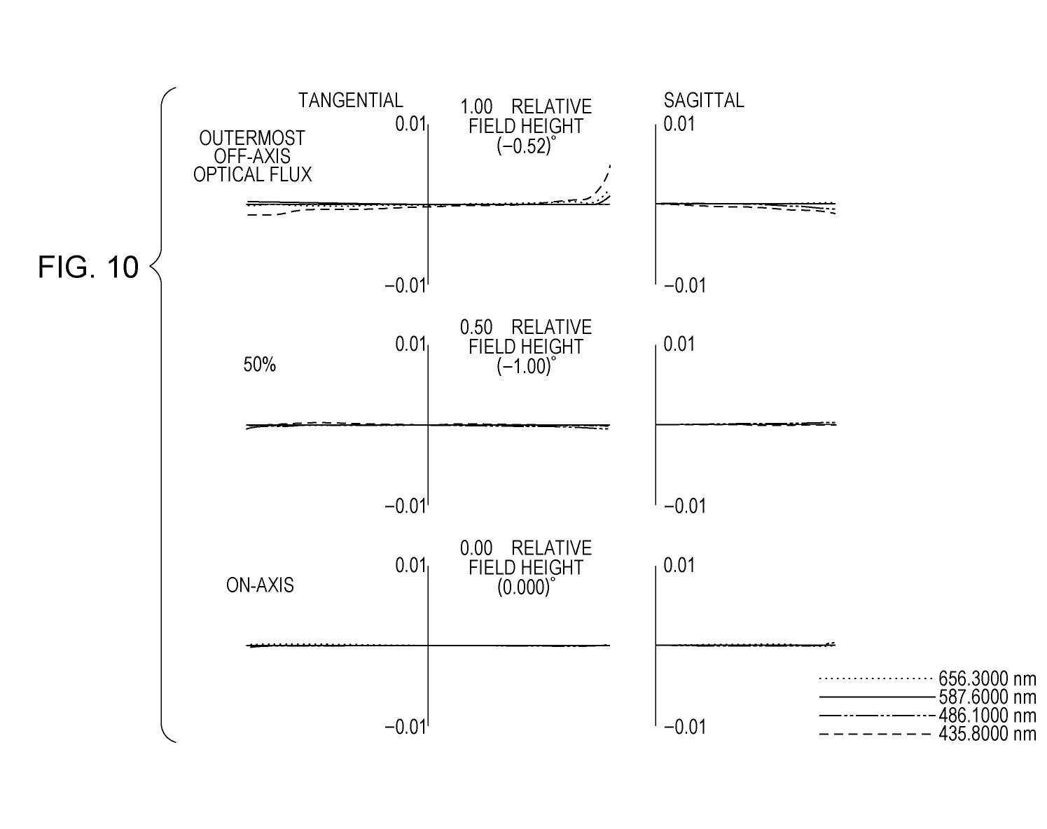

FIG. 8 is a schematic drawing of a principal portion of Example 3 of the catadioptric system which constitutes part of the image pickup apparatus of this disclosure. FIGS. 9A and 9B are respectively schematic drawings illustrating principal portions of the intermediate field lens and the image-side field lens of part of Example 3 of the catadioptric system of this disclosure. FIG. 10 is a transverse aberration diagram of Example 3 of the catadioptric system of this disclosure. In the transverse aberration diagram, calculation is performed on the sample (object), and values are indicated in units of millimeters (mm). In addition to results for a central wavelength of 587.6 nanometers (nm), the diagram also shows results for wavelengths of 656.3 nm, 486.1 nm, and 435.8 nm.

Referring now to FIG. 1, a configuration of the image pickup apparatus of this disclosure will be described. Here, FIG. 1 is a schematic block diagram of an image pickup apparatus 1000 of this disclosure. The image pickup apparatus 1000 condenses light from a light source (light source device) 101 by using an illumination optical system 102, and illuminates a sample (object) 103 uniformly. In one embodiment, the light used for illumination is visible light having a wide wavelength range (for example, light having wavelength ranging from 400 nm to 700 nm). However, other applications may use light in the ultra-violet (UV) or infrared (IR) wavelength ranges. An imaging optical system 104 is composed of a catadioptric system configured to form an image of the sample (object) 103 on an image pickup element 105 such as a CCD sensor or a CMOS sensor.

In the catadioptric system 104, aberration is corrected in a wavelength range equal to that used for illumination. That is, in one example, the catadioptric system 104 corrects aberrations in a wavelength range from a wavelength of 400 nm to a wavelength of 700 nm. An image processing system 106 generates image data from data (image information) obtained by the image pickup element 105, and a display (display unit) 107 displays the generated image data. In addition, a memory 110 configured to store image data processed by the image processing system 106 is also provided. The image processing system 106 performs processing in accordance with intended applications, such as correcting an aberration which failed to be fully corrected by the imaging optical system 104, or connecting a plurality of pieces of image data picked up at different positions and combining the same into a single piece of image data. The image processing system 106 can be implemented, for example, by a computer having one or more microprocessors operatively connected to memory (e.g., memory 110).

The catadioptric system 104 illustrated in FIG. 2, FIG. 5, and FIG. 8 will be described. The catadioptric system 104 of the respective examples includes a catadioptric unit CAT, an intermediate field lens IFL, a refracting (refractive) portion DIO, and an image-side field lens FL.

The catadioptric unit CAT includes a reflecting surface and a refracting surface, condenses optical flux from the sample (object) 103, and forms an intermediate image IM on a predetermined surface. The intermediate field lens IFL condenses the optical flux from the catadioptric unit CAT, and introduces the optical flux towards the refracting portion DIO, described later. The refracting portion DIO condenses the optical flux from the intermediate field lens IFL, and introduces the condensed light to the image-side field lens FL. The intermediate image IM is formed on the image pickup element (image surface) by using the refracting portion DIO and the image-side field lens FL.

The catadioptric unit CAT includes a first optical element (Mangin Mirror) M1 and a second optical element (Mangin Mirror) M2 from the object side to the image side in this order. The first optical element M1 includes a light transmitting portion M1T having a convex surface on the object side and having a positive refractive power in an area surrounding an optical axis AX, and a back-surface reflecting portion M1a provided with a reflecting film (for example, aluminum or silver) formed on the object side on the outer peripheral side of the light transmitting portion M1T.

The second optical element M2 includes a light transmissive portion M2T having a concave surface facing the object side, having a meniscus shape, and having a negative refractive power in the area surrounding the optical axis, and a back-surface reflecting portion M2b provided with a reflecting film (aluminum, silver, or the like) formed on the image side of the peripheral portion on the outer peripheral side of the light transmissive portion M2T. The first optical element M1 and the second optical element M2 are arranged so that the back-surface reflecting portions M1a and M2b oppose each other optically. The refracting portion DIO includes a refractive optical element, an aperture stop AS, and a light-shield plate SH configured to block part of optical flux from the sample 103 present in the vicinity of the optical axis AX and block part of the optical flux incident upon the image pickup element 105.

In Examples 1 and 2, the refracting portion DIO includes the aperture stop AS. The aperture stop AS is arranged on the light-shield plate SH or in the vicinity thereof. In Example 3, the catadioptric unit CAT includes the aperture stop AS.

The intermediate field lens IFL (shown in FIG. 3A) includes a positive lens and a negative lens, and the image-side field lens FL (shown in FIG. 3B) includes a positive lens and a negative lens. As shown in FIG. 3A, opposing lens surfaces of a positive lens IFLp1 and a negative lens IFLn1 of the intermediate field lens IFL adjacent to each other, optical flux from the object, namely on-axis optical flux and outermost off-axis optical flux pass through areas different from each other. Similarly, as shown in FIG. 3B, opposing lens surfaces of a positive lens FLp1 and a negative lens FLn1 of the image-side field lens FL adjacent to each other, optical flux from the object, namely on-axis optical flux and outermost off-axis optical flux pass through areas different from each other.

Here, the outermost off-axis optical flux is optical flux incident on a position farthest from an optical axis in an effective image pickup range of the image pickup element. Configurations of the intermediate field lens IFL in Examples 1 and 2 illustrated in FIG. 3A and FIG. 6A are cemented lenses formed by cementing a pair of the positive lens IFLp1 and the negative lens IFLn1 to each other. A configuration in Example 3 illustrated in FIG. 9A is composed of a cemented lens formed by cementing a pair of the positive lens IFLp1 and the positive lens IFLn1, and a positive lens IFLp2 to each other.

In the respective examples, surfaces of the positive lens IFLp1 and the negative lens IFLn1 adjacent to each other (opposing each other) correspond to a cemented surface (cemented lens surface) IFLSpn. The cemented surface IFLSpn includes an area where on-axis optical flux La1 passes through and an area where the outermost off-axis optical fluxLa2 passes through are arranged so as not to overlap each other. In other words, the on-axis optical flux La1 and the outermost off-axis optical fluxLa2 pass through different areas of the cemented surface IFLSpn. The image-side field lens FL is composed of a positive lens FLp2, and a cemented lens formed by cementing the positive lens FLp1 and the negative lens FLn1 in Example 1 illustrated in FIG. 3B.

The field lens of Example 2 illustrated in FIG. 6B includes the negative lens FLn1, the positive lens FLp1, and the positive lens FL2p. The field lens of the example illustrated in FIG. 9B includes a negative lens FLn2, a cemented lens formed by cementing the negative lens FLn1 and the positive lens FLp1, the positive lens FLp2, and a positive lens FLp3 to one another. The area where the on-axis optical flux La1 passes through and the area where the outermost off-axis optical fluxLa2 passes through are configured not to overlap with a surface where the positive lens FLp1 and the negative lens FLn1 which are adjacent to each other abut (oppose) each other in the respective examples, that is, a cemented lens surface FLSpn in FIG. 3B and FIG. 9B.

In FIG. 6B, the area where the on-axis optical flux La1 passes through and the area where the outermost off-axis optical fluxLa2 passes through are configured not to overlap with a lens surface FLSn and a lens surface FLSp. In the catadioptric system 104 of the respective examples, optical flux illuminated by optical flux from the illumination optical system 102 and emitted from the sample 103 passes through a transmissive portion M1T at a center area of the first optical element (Mangin mirror) M1. Subsequently, the optical flux is incident on the refracting surface M2a of the second optical element (Mangin mirror) M2 and, subsequently, is reflected from the back-surface reflecting portion M2b, passes through the refracting surface M2a, and is incident on a refracting surface M1b of the first optical element M1. Subsequently, the optical flux is reflected from the back-surface reflecting portion M1a of the first optical element M1.

Then, the optical flux passes through the refracting surface M1b of the first optical element M1, passes through the transmissive portion M2T at a center area of the second optical element M2, and is emitted toward the intermediate field lens IFL, thereby forming the intermediate image IM of the sample 103. The intermediate image IM is formed in the interior of the intermediate image field lens IFL including at least a pair of the positive lens and the negative lens or in the vicinity thereof. The intermediate image IM is condensed at the refracting portion DIO including a plurality of refractive optical elements, and then is imaged on the image pickup element 105 via the image-side field lens FL including at least a pair of the positive lens and the negative lens at an enlarged scale.

The image of the sample 103 formed on the image pickup element 105 is processed by the image processing system 106, and is displayed on the display 107. In the respective examples, the intermediate field lens IFL and the image-side field lens FL each include at least a pair of the positive lens and the negative lens adjacent to each other in the direction of optical axis. The on-axis optical flux and the outermost off-axis optical flux pass through areas different from each other on opposed lens surfaces of a pair of the positive lens and the negative lens of the respective field lenses.

In this configuration, chromatic high-order aberration is corrected to the off-axis by the intermediate field lens IFL, and telecentric properties of each color are enhanced to the off-axis side by the image-side field lens FL. Consequently, a catadioptric system having a high resolution power and a wide image pickup area is achieved in which the telecentric properties are maintained while the various aberrations satisfactorily is corrected over an entire visual light range.

In the respective examples, the back-surface reflecting portion M1a of the first optical element M1 and the back-surface reflecting portion M2b of the second optical element M2 composed of two Mangin mirrors are configured to be reflecting surfaces having a positive refractive power, and are formed into an aspherical shape, so that the various aberrations such as spherical aberration are satisfactorily corrected without generating chromatic aberration. In addition, the following effects are achieved by providing the refracting surface M2a of the second optical element M2 with a strong diverging effect (negative refractive power).

The size of the light transmitting portion M1T in the vicinity of a center of the first optical element M1 having a condensing effect may be relatively reduced. Since the on-axis chromatic aberration between the catadioptric unit CAT and the refracting portion DIO may be canceled out, the power of the positive lens of the refracting portion DIO (the refracting power of the positive lens) can be enhanced, so that the reduction of the entire lens length (the length from the first lens surface to the image surface) is facilitated.

At this time, a pair of adjacent positive and negative lenses are arranged in each of the intermediate field lens IFL and the image-side field lens FL as described above, and are configured so that the area where the on-axis optical flux passes through and the area where the outermost off-axis optical flux passes through do not overlap each other in the adjacent lens surfaces of the positive lens and the negative lens. Accordingly, the catadioptric system has a high resolution power over a wide area, while satisfactorily correcting various aberrations over the entire visual light range and, simultaneously, satisfactorily maintaining the telecentric properties. In the respective examples, the catadioptric system 104 has an aberration corrected in a wavelength range at least from 400 to 700 nm.

In the respective examples, Abbe numbers of materials of the positive lens IFLp1 and the negative lens IFLn1 are defined as νIFLp1 and νIFLn1. Abbe numbers of materials of the positive lens FLp1 and the negative lens FLn1 are defined as νFLp1 and νFLn1. At this time, conditions of

20<νIFLp1−νIFLn1 (1a)

20<νFLp1−νFLn1 (1b)

are preferably satisfied.

The conditional expressions (1a) and (1b) are for obtaining a high optical performance over a visible light range. When the conditional expressions (1a) and (1b) are not satisfied, the radii of curvature of the lens surfaces of the positive lens and the negative lens which constitute part of the field lens become smaller, so that the manufacture of the lens becomes difficult. In addition, having a high resolution power over a wide image pickup area while satisfactorily maintaining the various aberration or the telecentric property over the entire visual light range and obtaining a high optical performance become difficult. Further preferably, numerical values of the conditional expressions (1a) and (1b) are preferably set as below.

30<νIFLp1−νIFLn1 (1aa)

30<νFLp1−νFLn1 (1bb)

In the respective examples, radii of curvature of the opposing lens surfaces of the positive lens IFLp1 and the negative lens IFLn1 are defined as RIFLp1 and RIFLn1, respectively. Radii of curvature of the opposing lens surfaces of the positive lens FLp1 and the negative lens FLn1 are defined as RFLp1 and RFLn1, respectively.

At this time, conditions of

0.5<RIFLp1/RIFLn1<2.0 (2a)

0.5<RFLp1/RFLn1<2.0 (2b)

are preferably satisfied.

The conditional expressions (2a) and (2b) are for maintaining the chromatic aberration or the telecentric properties for each color. If the conditional expressions (2a) and (2b) are not satisfied, it is disadvantageous because the chromatic aberration or the telecentric properties for each color cannot be maintained. Further preferably, numerical values of the conditional expressions (2a) and (2b) are preferably set as below.

0.75<RIFLp1/RIFLn1<1.60 (2aa)

0.75<RFLp1/RFLn1<1.60 (2bb)

Subsequently, characteristics of the respective examples will be described.

### Example 1

In Example 1, the conditional expressions (2a) and (2b) are satisfied by a configurations of the cemented lens formed by cementing a pair of the positive lens IFLp1 and the negative lens IFLn1 included in the intermediate field lens IFL and adjacent to each other. Then, the telecentric property is satisfactorily maintained while correcting the various aberrations satisfactorily over the entire visual light range.

In the catadioptric system of Example 1, the numerical aperture NA on the object side is 0.7, and the imaging magnification is 4 times, and the height of the object of the sample 103 is φ7 mm. Both the object side and the image side are configured to be telecentric, and the difference of the telecentric property for each color is restrained to a level lower than 0.1 degree. The error of the wavefront aberration in white light is restrained to a level not higher than 100 mλ (rms).

### Example 2

In Example 2, a pair of the positive lens FLp1 and the negative lens FLn1 of the image-side field lens FL are composed of independent lenses, and satisfy the conditional expressions (2a) and (2b), so that the telecentric property is satisfactorily maintained while correcting the various aberrations satisfactorily over the entire visual light range.

In the catadioptric system of Example 2, the numerical aperture NA on the object side is 0.7, and the imaging magnification is 6 times, and the height of the object of the sample 103 is φ7 mm. Both the object side and the image side are configured to be telecentric, and the difference of the telecentric property for each color is restrained to a level lower than 0.1 degree. The error of the wavefront aberration in white light is restrained to a level not higher than 100 mλ (rms).

### Example 3

In Example 3, the catadioptric unit CAT includes the aperture stop AS in the interior thereof. In the catadioptric system of Example 3, the numerical aperture NA on the object side is 0.7, and the imaging magnification is 10 times, and the height of the object of the sample 103 is φ7 mm. Both the object side and the image side are configured to be telecentric, and the difference of the telecentric property for each color is restrained to a level lower than 0.1 degree. The error of the wavefront aberration in white light is restrained to a level not higher than 100 mλ (rms).

As described thus far, according to the examples described above, the image pickup apparatus including a catadioptric system in which various aberrations are satisfactorily corrected over an entire visual light range, having a high resolution power over a wide image observation area, and having a high telecentric property is obtained.

Although the preferred examples of this disclosure have been described, this disclosure is not limited to those examples, and various modifications or variations may be made within the scope of this disclosure. For example, the catadioptric system of this disclosure may be applied both to an image pickup apparatus configured to scan a large sized screen and an image pickup apparatus configured not to scan the large sized screen.

Numerical examples of the catadioptric system of the respective examples will be described below. Surface numbers indicate the order of the optical surface when counting from the object surface (sample surface) to the image surface in the order of passage of the optical flux. Reference sign r denotes a radius of curvature of the ith optical surface. Reference sign d denotes a distance between the ith and the (i+1)th optical surfaces (+ sign indicates when measurement is done from the object side to the image surface side (when the light travels) and − sign indicates a negative direction). Nd and νd indicate that the refractive index and Abbe number of the material with respect to a wavelength of 587.6 nm, respectively.

The shape of the aspherical surface is expressed by an expression of a general aspherical surface illustrated in the following expression. In the following expression, Z is a coordinate in the direction of optical axis, c is a curvature (reciprocal of the radius of curvature r), h is a height from an optical axis, k is a coefficient of curvature, A, B, C, D, E, F, G, H, J, and so forth are coefficients of aspherical surface of fourth order, sixth order, eighth order, tenth order, twelfth order, fourteenth order, sixteenth order, eighteenth order, twentieth order, and so forth.

$$z = \frac{{ch}^{2}}{1 + \sqrt{1 - ( 1 + k ) {c}^{2} {h}^{2}}} + {Ah}^{4} + {Bh}^{6} + {C h}^{8} + {Dh}^{10} + {E h}^{12} + {Fh}^{14} + {G h}^{16} + {Hh}^{18} + {Jh}^{20} + … \qquad [ Expression 1 ]$$

The scientific E notation “E-X” indicates an exponential base-10 notation “10^{-x}”. The relationship between the above-described respective conditional expressions and the numerical examples are shown in Table 1.

### Numerical Example 1

| Surface | | | | |
|---|---|---|---|---|
| Number | r | d | Nd | νd |
| Object | 4.548735 | | | |
| Surface | | | | |
| 1 | 521.4833 | 10.42778 | 51.63 | 64.14 |
| 2 | 1198.537 | 71.91445 | | |
| 3 | −83.5906 | 7.356464 | 51.63 | 64.14 |
| 4 | −113.055 | −7.35646 | 51.63 | 64.14 |
| 5 | −83.5906 | −71.9145 | | |
| 6 | 1198.537 | −10.4278 | 51.63 | 64.14 |
| 7 | 521.4833 | 10.42778 | 51.63 | 64.14 |
| 8 | 1198.537 | 71.91445 | | |
| 9 | −83.5906 | 7.356464 | 51.63 | 64.14 |
| 10 | −113.055 | 3.040876 | | |
| 11 | −188.33 | 5.071829 | 1.75 | 33.92 |
| 12 | 46.25732 | 8.776166 | 1.49 | 69.93 |
| 13 | −51.379 | 3.457397 | | |
| 14 | 53.63198 | 12.82361 | 1.51 | 67.62 |
| 15 | −88.3458 | 8.879021 | | |
| 16 | 46.17255 | 16.25461 | 1.71 | 47.59 |
| 17 | −93.1165 | 4.722488 | | |
| 18 | −70.4565 | 5 | 1.75 | 29.11 |
| 19 | −275.968 | 32.3078 | | |
| 20 | −26.5533 | 8.205358 | 1.76 | 27.58 |
| 21 | −35.4804 | 1.414069 | | |
| 22 | 1.00E+18 | 1.418539 | | |
| 23 | 393.1702 | 12.66315 | 1.63 | 50.26 |
| 24 | −78.9729 | 0.5 | | |
| 25 | 98.36622 | 13.97233 | 1.57 | 63.39 |
| 26 | −141.89 | 1.256678 | | |
| 27 | 60.3378 | 13.11688 | 1.75 | 31.20 |
| 28 | −994.544 | 0.588979 | | |
| 29 | −1169.76 | 5.103376 | 1.75 | 31.58 |
| 30 | 48.46664 | 28.35765 | | |
| 31 | −33.1409 | 5 | 1.61 | 37.27 |
| 32 | 831.641 | 18.72344 | | |
| 33 | −153.464 | 14.11247 | 1.64 | 56.87 |
| 34 | −51.9262 | 0.5 | | |
| 35 | 74.56586 | 16.86557 | 1.62 | 59.56 |
| 36 | −112.85 | 5 | 1.68 | 31.60 |
| 37 | 211.6056 | 8.620272 | | |
| Image | | | | |
| surface | | | | |

Coefficient of aspherical surface

| Surface | |
|---|---|
| Number | |
| 1, 7 | k = 0.00E+00 A = 4.09E−08 B = −1.52E−12 C = 6.23E−16 |
| | D = −8.34E−20 E = 1.82E−23 F = −2.67E−27 G = 2.45E−31 |
| 4, 10 | k = 0.00E+00 A = 1.46E−08 B = 1.60E−12 C = 1.46E−16 |
| | D = 9.29E−21 E = 1.76E−24 F = −1.12E−28 G = 2.25E−32 |
| 18 | k = 0.00E+00 A = −2.16E−06 B = −7.96E−10 C = −3.84E−13 |
| | D = 2.64E−15 E = −1.54E−18 F = 0.00E+00 G = 0.00E+00 |
| 20 | k = 0.00E+00 A = 1.23E−06 B = 7.11E−10 C = 1.86E−12 |
| | D = −8.69E−17 E = 3.07E−18 F = 0.00E+00 G = 0.00E+00 |
| 26 | k = 0.00E+00 A = −3.90E−07 B = 1.09E−09 C = −6.44E−13 |
| | D = 2.00E−16 E = −1.76E−20 F = −5.33E−24 G = 0.00E+00 |
| 30 | k = 0.00E+00 A = 4.16E−06 B = −1.09E−09 C = 1.07E−12 |
| | D = 1.99E−15 E = −3.41E−18 F = 3.59E−21 G = 0.00E+00 |
| 33 | k = 0.00E+00 A = 1.06E−06 B = 2.45E−11 C = −2.07E−13 |
| | D = 1.67E−16 E = −2.89E−19 F = 2.79E−22 G = −9.41E−26 |

### Numerical Example 2

| Surface | | | | |
|---|---|---|---|---|
| Number | r | d | Nd | νd |
| Object | 4.48267 | | | |
| Surface | | | | |
| 1 | 542.9976 | 11.19734 | 51.63 | 64.14 |
| 2 | 2581.476 | 65.2412 | | |
| 3 | −78.3122 | 6.866609 | 51.63 | 64.14 |
| 4 | −105.393 | −6.86661 | 51.63 | 64.14 |
| 5 | −78.3122 | −65.2412 | | |
| 6 | 2581.476 | −11.1973 | 51.63 | 64.14 |
| 7 | 542.9976 | 11.19734 | 51.63 | 64.14 |
| 8 | 2581.476 | 65.2412 | | |
| 9 | −78.3122 | 6.866609 | 51.63 | 64.14 |
| 10 | −105.393 | 3 | | |
| 11 | −345.367 | 7.270176 | 62.16 | 60.09 |
| 12 | −29.029 | 5 | 64.90 | 33.69 |
| 13 | −53.1824 | 5.505975 | | |
| 14 | 109.6718 | 7.953115 | 52.54 | 66.65 |
| 15 | −84.7588 | 3.773701 | | |
| 16 | 44.03214 | 13.62125 | 62.04 | 60.32 |
| 17 | −49.3515 | 0.5 | | |
| 18 | −103.894 | 5 | 75.52 | 27.61 |
| 19 | 54.02885 | 13.6406 | | |
| 20 | 1.00E+18 | 5.04281 | | |
| 21 | −267.232 | 10.26275 | 72.33 | 46.56 |
| 22 | −42.1763 | 36.68524 | | |
| 23 | −423.35 | 13.42666 | 68.89 | 50.00 |
| 24 | −49.4215 | 0.5 | | |
| 25 | 52.28456 | 11.52281 | 74.32 | 44.91 |
| 26 | 169.025 | 5.173315 | | |
| 27 | 309.7103 | 5 | 62.04 | 36.41 |
| 28 | 34.16828 | 19.8749 | | |
| 29 | −90.3918 | 5 | 49.30 | 67.13 |
| 30 | 255.7377 | 24.8303 | | |
| 31 | −32.7311 | 5 | 75.52 | 27.58 |
| 32 | −111.168 | 3 | | |
| 33 | −169.118 | 21.35711 | 48.75 | 70.41 |
| 34 | −45.75 | 0.5 | | |
| 35 | 223.8303 | 22.31531 | 48.75 | 70.41 |
| 36 | −105.607 | 7.607199 | | |
| Image | | | | |
| surface | | | | |

Coefficient of aspherical surface

| Surface | |
|---|---|
| Number | |
| 1, 7 | k = 0.00E+00 A = 3.14E−08 B = 1.96E−12 C = 1.50E−16 |
| | D = 5.69E−20 E = −2.37E−23 F = 7.70E−27 G = −8.12E−31 |
| 4, 10 | k = 0.00E+00 A = 1.38E−08 B = 1.78E−12 C = 2.01E−16 |
| | D = 1.35E−20 E = 4.44E−24 F = −4.2lE−28 G = 7.91E−32 |
| 18 | k = 0.00E+00 A = −6.51E−06 B = −1.70E−09 C = −8.36E−14 |
| | D = 1.70E−15 E = −2.18E−19 F = −6.56E−26 G = 0.00E+00 |
| 24 | k = 0.00E+00 A = 1.25E−06 B = 3.16E−10 C = −2.82E−14 |
| | D = 8.91E−17 E = −4.39E−20 F = 1.75E−23 G = 0.00E + 00 |
| 28 | k = 0.00E+00 A = 1.16E−06 B = 6.87E−10 C = 9.91E−13 |
| | D = 2.63E−15 E = −4.56E−18 F = 7.65E−21 G = 0.00E+00 |
| 36 | k = 0.00E+00 A = −1.00E−06 B = 8.32E−10 C = −6.76E−13 |
| | D = 4.24E−16 E = −1.75E−19 F = 4.18E−23 G = −4.30E−27 |

### Numerical Value Example 3

| Surface | | | | |
|---|---|---|---|---|
| Number | r | d | Nd | νd |
| Object | 5 | | | |
| Surface | | | | |
| 1 | 573.0926 | 11.40932 | 51.63 | 64.14 |
| 2 | −3916.13 | 70.74034 | | |
| 3 | −84.6952 | 7.289476 | 51.63 | 64.14 |
| 4 | −116.031 | −7.28948 | 51.63 | 64.14 |
| 5 | −84.6952 | −70.7403 | | |
| 6 | −3916.13 | −11.4093 | 51.63 | 64.14 |
| 7 | 573.0926 | 11.40932 | 51.63 | 64.14 |
| 8 | −3916.13 | 70.74034 | | |
| 9 | −84.6952 | 7.289476 | 51.63 | 64.14 |
| 10 | −116.031 | 5.015545 | | |
| 11 | −39.4543 | 6.889033 | 62.041 | 60.32 |
| 12 | −22.7623 | 5 | 74.8912 | 35.10 |
| 13 | −39.3312 | 0.5 | | |
| 14 | 47.78814 | 8.078701 | 60.0126 | 61.41 |
| 15 | −62.9182 | 16.40919 | | |
| 16 | 35.92122 | 11.52923 | 48.8481 | 69.79 |
| 17 | −94.357 | 21.4421 | | |
| 18 | −23.8795 | 5 | 75.3962 | 28.79 |
| 19 | −60.9281 | 2.862957 | | |
| 20 | 1.00E+18 | 1.530541 | | |
| 21 | 274.0142 | 14.04267 | 62.8709 | 58.71 |
| 22 | −64.1201 | 0.887846 | | |
| 23 | 225.4758 | 12.80297 | 68.9493 | 49.93 |
| 24 | −61.4939 | 0.5 | | |
| 25 | 51.8838 | 18.06069 | 75.1356 | 31.72 |
| 26 | 52.2339 | 44.74289 | | |
| 27 | −34.9243 | 5 | 62.3385 | 59.73 |
| 28 | 785.4749 | 45.64548 | | |
| 29 | −75.6302 | 5 | 75.5201 | 27.58 |
| 30 | −637.205 | 27.00348 | 62.041 | 60.32 |
| 31 | −78.0391 | 0.5 | | |
| 32 | −294.153 | 20.8202 | 48.749 | 70.41 |
| 33 | −108.5 | 0.5 | | |
| 34 | −572.455 | 22.79735 | 48.749 | 70.41 |
| 35 | −157.862 | 3 | | |
| Image | | | | |
| Surface | | | | |

Coefficient of Aspherical Surface

| Surface | |
|---|---|
| Number | |
| 1, 7 | k = 0.00E+00 A = 2.98E−08 B = −2.10E−12 C = 1.35E−15 |
| | D = −3.50E−19 E = 6.81E−23 F = −7.53E−27 G = 4.10E−31 |
| 4, 10 | k = 0.00E+00 A = 1.49E−08 B = 1.60E−12 C = 1.31E−16 |
| | D = 9.91E−21 E = 1.35E−24 F = −7.86E−29 G = 1.44E−32 |
| 14 | k = 0.00E+00 A = −4.67E−06 B = 4.21E−09 C = −3.67E−11 |
| | D = 1.43E−13 E = −1.87E−16 F = −1.09E−19 G = 0.00E+00 |
| 19 | k = 0.00E+00 A = −2.20E−06 B = −2.79E−09 C = 1.06E−12 |
| | D = 2.33E−16 E = −2.27E−17 F = 1.62E−20 G = 0.00E+00 |
| 22 | k = 0.00E+00 A = −4.47E−07 B = −1.35E−09 C = 1.09E−12 |
| | D = 9.35E−16 E = −3.33E−19 F = −1.97E−23 G = 0.00E+00 |
| 24 | k = 0.00E+00 A = 2.83E−06 B = 9.48E−10 C = −6.33E−13 |
| | D = −4.38E−16 E = 3.52E−19 F = −7.47E−23 G = 0.00E+00 |
| 28 | k = 0.00E+00 A = 1.99E−06 B = −1.46E−10 C = −3.91E−13 |
| | D = 4.92E−17 E = 1.71E−19 F = −1.24E−22 G = 0.00E+00 |
| 35 | k = 0.00E+00 A = −4.22E−07 B = 1.57E−10 C = −4.70E−14 |
| | D = 8.09E−18 E = −7.33E−22 F = 2.31E−26 G = 4.70E−31 |

TABLE 1

| | Examples | | |
|---|---|---|---|
| Conditional Expression | 1 | 2 | 3 |
| (1a) νIFLp1 − νIFLn1 | 36.01 | 26.4 | 25.22 |
| (1b) νFLp1 − νFLn1 | 27.96 | 42.83 | 32.74 |
| (2a) RIFLp1/RIFLn1 | 1 | 1 | 1 |
| (2b) RFLp1/RFLn1 | 1 | 1.52 | 1 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-167376, filed Aug. 12, 2013 which is hereby incorporated by reference herein in its entirety.

What is claimed is:

1. A catadioptric system comprising:
a catadioptric unit configured to form an intermediate image of an object;
a refracting portion configured to form an image of the intermediate image;
a first field lens configured to guide optical flux from the catadioptric unit to the refracting portion; and
a second field lens configured to guide the optical flux from the refracting portion toward an image side, wherein
the first and the second field lenses each include a positive lens and a negative lens adjacent to each other, and wherein
where νIFLp1 and νIFLn1 are respectively Abbe numbers of materials of the positive lens and the negative lens of the first field lens, and νFLp1 and νFLn1 are respectively Abbe numbers of materials of the positive lens and the negative lens of the second field lens, conditions
20<νIFLp1−νIFLn1 and
20<νFLp1−νFLn1
are satisfied.

2. The image pickup apparatus according to claim 1, wherein on-axis optical flux and outermost off-axis optical flux from the object pass through areas different from each other in each of lens surfaces of the positive lens and the negative lens opposing each other of the first field lens, and lens surfaces of the positive lens and the negative lens opposing each other of the second field lens.

3. The catadioptric system according to claim 1, wherein
where RIFLp1 and RIFLn1 are respectively radii of curvature of the lens surfaces of the positive lens and the negative lens opposing each other of the first field lens, and RFLp1 and RFLn1 are respectively radii of curvature of the lens surfaces of the positive lens and the negative lens opposing each other of the second field lens, conditions
0.5<RIFLp1/RIFLn1<2.0 and
0.5<RFLp1/RFLn1<2.0
are satisfied.

4. The catadioptric system according to claim 1, wherein
the catadioptric unit includes a first optical element including a transmissive portion provided in an area surrounding an optical axis and a reflecting portion provided on a surface on the object side, and a second optical element including a transmissive portion provided in an area surrounding an optical axis and a reflecting portion provided on the surface on the image side in this order from the object side toward the image side,
optical flux from the object is incident on the first field lens via the transmissive portion of the first optical element, the reflecting portion of the second optical element, the reflecting portion of the first optical element, and the transmissive portion of the second optical element in this order.

5. The catadioptric system according to claim 4, wherein
the surface of the first optical element on the object side has a convex shape, the second optical element has a meniscus shape with a depressed surface facing toward the object, the transmissive portion of the first optical element has a positive refractive power, and the transmissive portion of the second optical element has a negative refractive power.

6. The catadioptric system according to claim 1, wherein the positive lens and the negative lens of the first field lens, and the positive lens and the negative lens of the second field lens are respectively cemented lenses.

7. An image pickup apparatus comprising:
a catadioptric system configured to form an image of an object; and
an image pickup device configured to perform photoelectric conversion on the image of the object wherein
the catadioptric system includes a catadioptric unit configured to form an intermediate image of the object, a refracting portion configured to form an image of the intermediate image, a first field lens configured to guide optical flux from the catadioptric unit to the refracting portion, and a second field lens configured to guide the optical flux from the refracting portion toward the image side,
wherein the first and the second field lenses each include a positive lens and a negative lens adjacent to each other,
wherein where νIFLp1 and νIFLn1 are respectively Abbe numbers of materials of the positive lens and the negative lens of the first field lens, and νFLp1 and νFLn1 are respectively Abbe numbers of materials of the positive lens and the negative lens of the second field lens, conditions
20<νIFLp1−νIFLn1 and
20<νFLp1−νFLn1
are satisfied.

8. The image pickup apparatus according to claim 7, further comprising a light source device, an illumination optical system configured to illuminate the object with optical flux from the light source device; and an image processing system configured to generate image information by an output from the image pickup device.

9. The image pickup apparatus according to claim 7, wherein on-axis optical flux and outermost off-axis optical flux from the object pass through areas different from each other in each of lens surfaces of the positive lens and the negative lens opposing each other of the first field lens, and lens surfaces of the positive lens and the negative lens opposing each other of the second field lens.

10. The image pickup apparatus according to claim 7, wherein
where RIFLp1 and RIFLn1 are respectively radii of curvature of the lens surfaces of the positive lens and the negative lens opposing each other of the first field lens, and RFLp1 and RFLn1 are respectively radii of curvature of the lens surfaces of the positive lens and the negative lens opposing each other of the second field lens, conditions
0.5<RIFLp1/RIFLn1<2.0 and
0.5<RFLp1/RFLn1<2.0
are satisfied.

11. The image pickup apparatus according to claim 7, wherein
the catadioptric unit includes a first optical element including a transmissive portion provided in an area surrounding an optical axis and a reflecting portion provided on a surface on the object side, and a second optical element including a transmissive portion provided in an area surrounding an optical axis in this order from the object side toward the image side, and
optical flux from the object is incident on the first field lens via the transmissive portion of the first optical element, the reflecting portion of the second optical element, the reflecting portion of the first optical element, and the transmissive portion of the second optical element in this order.

12. The image pickup apparatus according to claim 11, wherein the surface of the first optical element on the object side has a convex shape, the second optical element has a meniscus shape with a depressed surface facing toward the object, the transmissive portion of the first optical element has a positive refractive power, and the transmissive portion of the second optical element has a negative refractive power.

13. The image pickup apparatus according to claim 7, wherein the positive lens and the negative lens of the first field lens, and the positive lens and the negative lens of the second field lens are respectively cemented lenses.
